(19) United States
(12) Patent Application Publication
(10) Pub. No.: US 2026/0370669 A1
(43) Pub. Date: Nov. 19, 2026

(54) SYSTEMS AND METHODS FOR SAMPLING OF CONTEXT WINDOWS FOR EFFICIENT CUSTOMER MANAGEMENT RISK ESTIMATION

(71) Applicant: Capital One Services, LLC, McLean, VA (US)

(72) Inventors: Samuel SHARPE, Somerville, MA (US); James O. H. MONTGOMERY, Vienna, VA (US); Shinjini BASU, Brooklyn, NY (US)

(73) Assignee: Capital One Services, LLC, McLean, VA (US)

(21) Appl. No.: 19/207,304

(22) Filed: May 13, 2025

(51) Int. Cl. H04L 9/40; G06N 3/045; G06N 3/09

(52) U.S. Cl. CPC H04L 63/1425; G06N 3/045; G06N 3/09; H04L 63/1416; H04L 63/1441

(57) ABSTRACT

Described herein include systems and methods for preventing adverse network data access to secure network data corresponding to an authorized electronic resource. For example, the system may train an artificial intelligence model, such as a transformer model, to predict a future state of an authorized electronic resource and, depending on the predicted state, take one or more actions (e.g., disabling services, enabling services, etc.). The artificial intelligence model may be trained using a computationally efficient training technique that uses less network data than conventionally needed to train models without the context loss generally associated with reduced quantities of training network data.

### BACKGROUND

In recent years, the use of artificial intelligence, including, but not limited to, machine learning, deep learning, etc. (referred to collectively herein as artificial intelligence models, machine learning models, or simply models) has exponentially increased and can be used to improve the results of certain tasks. However, despite their wide range of applications artificial intelligence models may be computationally intensive to train, relying on exponentially large amounts of high-quality network data. Further complexing matters is the difficulty in obtaining (and ensuring it really is) high-quality network data is computationally intensive and time-consuming.

### SUMMARY

Systems and methods are described herein for novel uses and/or improvements to artificial intelligence applications. As one example, systems and methods are described herein for preventing adverse network data access to secure network data corresponding to an authorized electronic resource. For example, the system may train an artificial intelligence model, such as a transformer model, to perform a task (e.g., predict the likelihood of an adverse event occurring within a predefined amount of time for an authorized electronic resource) by using a computationally efficient training technique that uses less network data than conventionally needed to train models without the context loss commonly associated with using reduced quantities of training network data.

Training an artificial intelligence model, such as a transformer model, is technically challenging using existing solutions due to multiple factors. First, such training is typically computationally intensive and requires an exponentially large amount of network data. For example, network data sequences corresponding to each event, day, week, etc., in the lifetime of an authorized electronic resource and/or a plurality of authorized electronic resources (e.g., 103 or more authorized electronic resources, 106 or more authorized electronic resources, 108 or more authorized electronic resources, etc.). It is computationally expensive to process network data sequences for each event because that requires running the model for each new event. Second, using such an exponentially large amount of network data creates several technical problems in terms of network data storage. As authorized electronic resource lifetimes, as well as authorized electronic resources, increase, so does the network data representing those authorized electronic resources. This increase in resource consumption needed to store the network data has several associated technical and practical problems, including, for instance, purchasing cloud storage resources, powering computing stacks and servers to facilitate storage of the network data, maintaining security of stored network data, and the like. While a naïve approach may include simply using less network data to train the model, this approach also creates several technical problems, such as the introduction of bias or loss of context, both of which can lead to decreased model accuracy.

In view of these technical challenges, the systems and methods use a computationally efficient artificial intelligence model training technique that reduces training times and computing resource consumption, without decreasing model accuracy. To facilitate such a computationally efficient artificial intelligence model training technique, the described technical solutions may generate and store state change network data. State change network data can be used for event sequence sampling and proxy-labeling. The system may then detect instances where the state changes among all the network data instances and weight those instances appropriately while ignoring or deleting the other instances. Thus, the system does not have to process the instances where nothing happened. The state change network data may include information about each state change experienced by each authorized electronic resource. A state change refers to a change in computing state of an authorized electronic resource. The state change network data can store the state change events associated with a given authorized electronic resource.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., network data), unless the context clearly dictates otherwise.

### BRIEF DESCRIPTION OF THE DRA WINGS

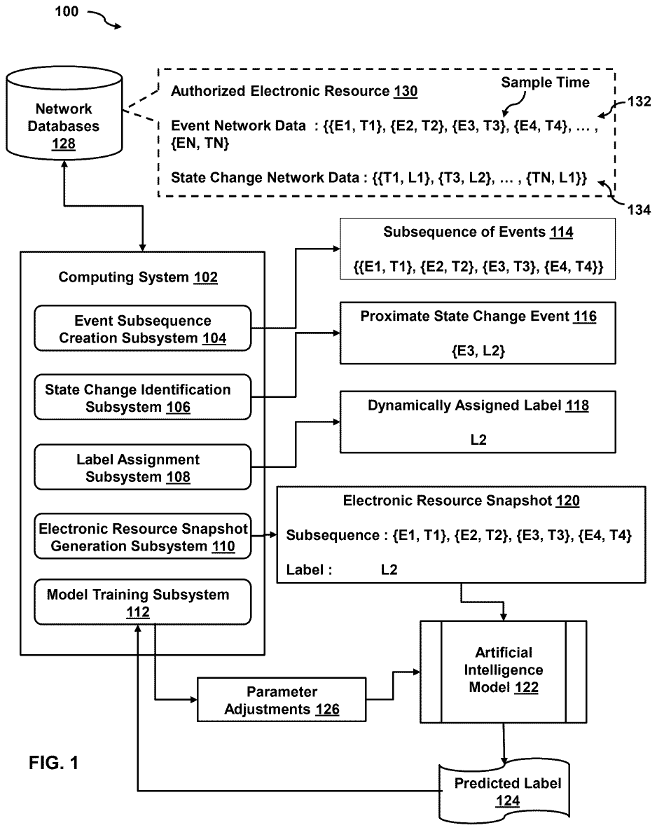

FIG. 1 shows an illustrative diagram of an example system used to train an artificial intelligence model to perform a task related to detecting adverse network data access attempts, in accordance with one or more embodiments.

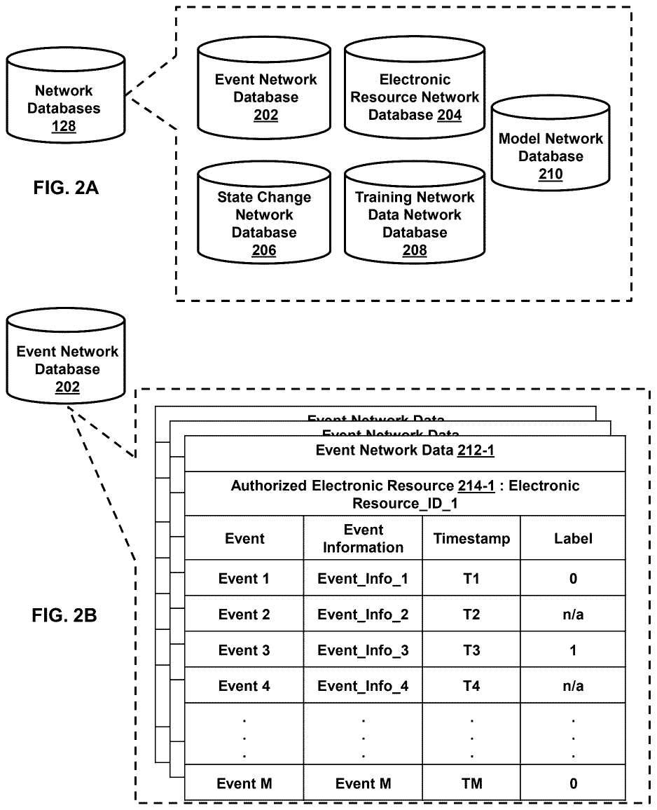

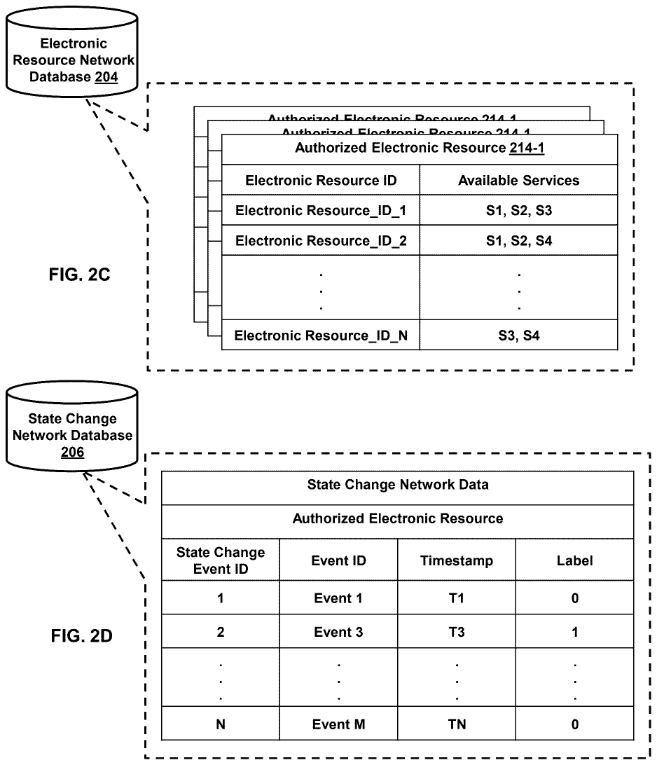

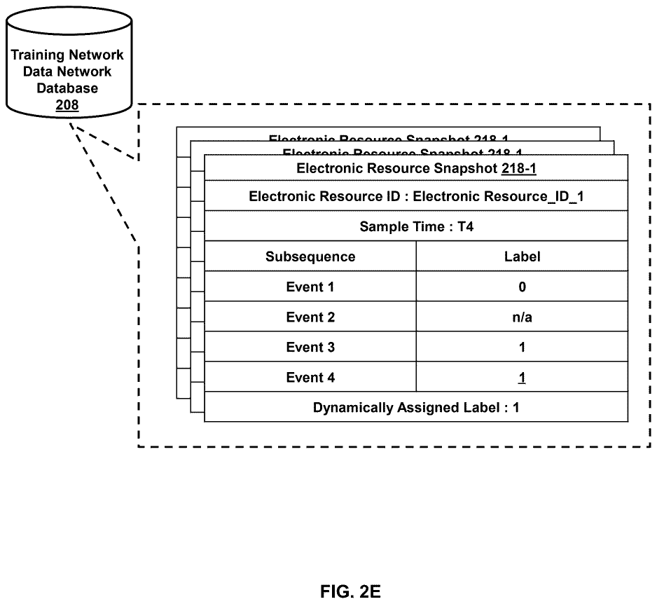

FIGS. 2A-2E show illustrative diagrams of example network databases and network data structures employed by the example system of FIG. 1, in accordance with one or more embodiments.

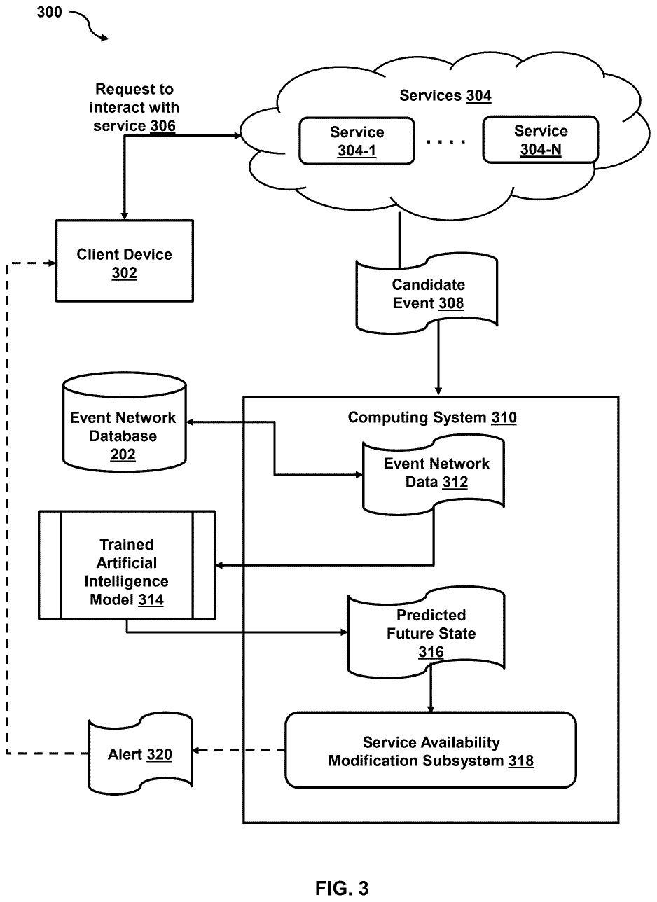

FIG. 3 shows an illustrative diagram of an example system leveraging a trained artificial intelligence model to detect and prevent an adverse network data access attempt, in accordance with one or more embodiments.

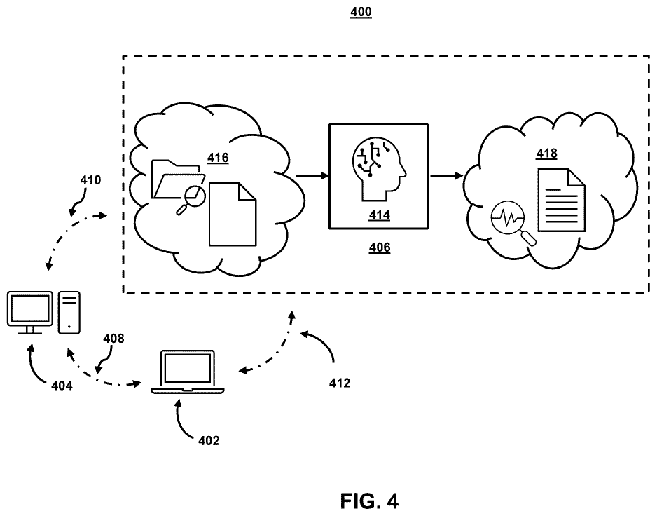

FIG. 4 shows an illustrative diagram of an example system used to facilitate the training and use of an artificial intelligence model to detect and prevent adverse network data access attempts, in accordance with one or more embodiments.

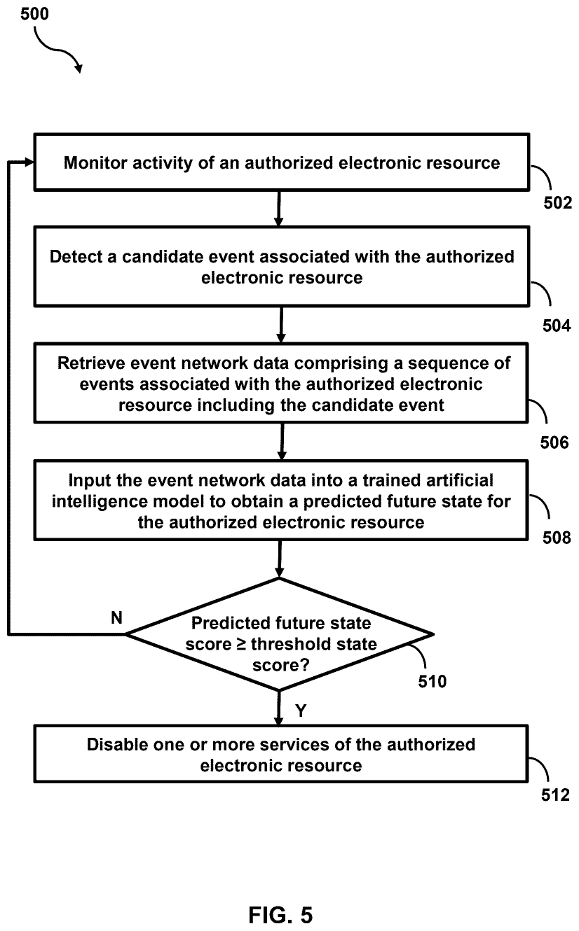

FIG. 5 shows an illustrative flowchart of an example process for preventing adverse network data access attempts, in accordance with one or more embodiments.

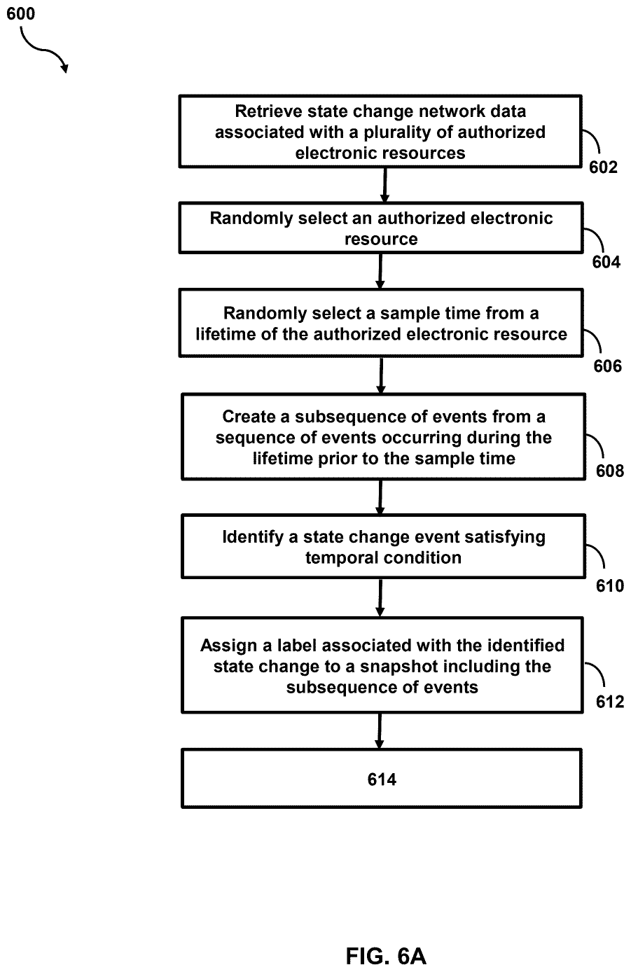

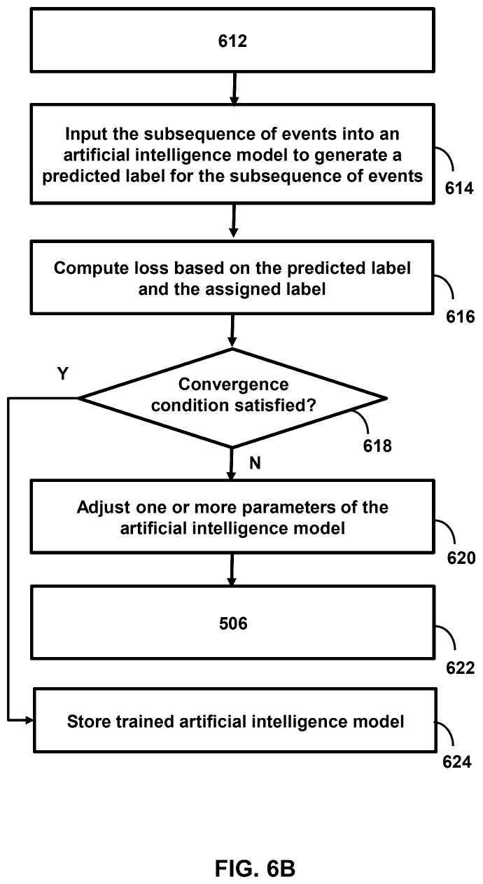

FIGS. 6A-6B show an illustrative flowchart of an example process for training an artificial intelligence model to perform a task related to detecting adverse network data access attempts, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

To train an artificial intelligence model to predict a future state of an authorized electronic resource, the state change network data may be leveraged. For example, a sample time during the lifetime of the authorized electronic resource (i.e., some time from authorized electronic resource creation until a present time) may be randomly selected. Based on the sample time, a subsequence of events may be created from the sequence of events of the authorized electronic resource. For example, if a sequence includes ten sequential events (e.g., {{Event 1, Time 1}, {Event 2, Time 2}, . . . , {Event 10, Time 10}}), and the randomly selected sample time is Time 4, then the subsequence of events created may include the first four events in the sequence (e.g., {{Event 1, Time 1}, {Event 2, Time 2}, {Event 3, Time 3}, {Event 4, Time 4}}). The state change network data may then be accessed to identify a state change event that is temporally most proximate to the selected sample time. For example, using the ten sequential events mentioned above, the state change network data may indicate that a state change event was detected responsive to Event 3 and Event 9. As Event 3, which occurred at Time 3, is temporally closer to the selected sample time (e.g., Time 4), a state of the authorized electronic resource at Time 3 may be determined. A label may be assigned to the subsequence of events corresponding to the label assigned to the identified state change event. For example, if, at Time 3, subsequent to Event 3, the authorized electronic resource is determined to be in a first computing state represented using a first label, then the subsequence of events including the first four events may also be assigned the first label. The subsequence of events can be input to the artificial intelligence model to obtain a predicted computing state of the authorized electronic resource, which can be compared to the first computing state determined from the state change event network data. An optimization process, such as computing a loss and adjusting parameters of the model based on the loss, may be performed to enable the artificial intelligence model to learn to the desired task (i.e., predict computing state).

Technical advantages are observed by the technical solutions described herein by enhancing training efficiency, reduced training time, and improving model accuracy. For example, a technical advantage of this technical solution is that the training process is more efficient. Computing resources consumed during training can be significantly reduced (i.e., instead of using every subsequence for every authorized electronic resource, only a sampled few can be used). Another technical advantage of consuming fewer computing resources is reduced computing and monetary cost in purchasing and maintaining computing resources to process such network data, as well as energy to power computing hardware to process the network data. Yet another technical advantage of the technical solution is that the training process described herein is faster due to the reduced amount of network data needed to train the model. Still further, model accuracy can be improved using the described training process.

Subsequent to training the artificial intelligence model, the deployed model provides still more technical benefits. Leveraging the technical solutions described above, access to secure network data associated with a given authorized electronic resource may be monitored so as to identify and prevent adverse network data access attempts. For example, a detected event may be analyzed to determine whether it could be a candidate for a potential adverse event (e.g., network data security breach). To do so, event network data including the sequence of events associated with that authorized electronic resource, up to and/or including the detected event, may be retrieved. This retrieved event network data can then be input into the trained artificial intelligence model to obtain a predicted future state of the authorized electronic resource. In some cases, a score indicating whether the event is an adverse event may be computed using the trained artificial intelligence model and compared to a threshold score. If the predicted future state score is determined to be greater than or equal to the threshold score, this may indicate that the detected event is likely an adverse event. Therefore, to prevent the detected event from accessing secure network data stored by the authorized electronic resource, one or more services of the authorized electronic resource may be (temporarily or permanently) disabled, thus preventing possible and/or further harm from the adverse event.

In some aspects, systems and methods for preventing adverse network data access to secure network data are described. For example, a method for preventing adverse network data access to secure network data may include detecting a candidate event associated with an authorized electronic resource and retrieving event network data comprising a sequence of events associated with the authorized electronic resource including the candidate event. The method may also include inputting the event network data into a trained artificial intelligence model to obtain a predicted future state of the authorized electronic resource, wherein the trained artificial intelligence model is trained using one or more authorized electronic resource snapshots and dynamically assigned labels determined based on the one or more authorized electronic resource snapshots. The method may additionally include disabling, based on the predicted future state, one or more services of the authorized electronic resource.

Systems and methods described herein may use a unique artificial intelligence training architecture. For example, the system may use a computationally efficient architecture for training an artificial intelligence model to prevent adverse network data access to secure network data. Secure network data may include any data relating to an authorized electronic resource. For example, after a first event occurs for an authorized electronic resource at a first time (e.g., a computing task is performed using a service subscribed to by the authorized electronic resource, a transaction is performed using a resource maintained by the authorized electronic resource, a request is submitted to or received from the authorized electronic resource, etc.), a first sequence of events representing the authorized electronic resource may be created. This first sequence of events may include each event, associated with the authorized electronic resource, that has occurred during the lifetime of the authorized electronic resource (i.e., from creation of the authorized electronic resource to a given event's occurrence). Each event may include event context information describing the event that occurred (e.g., text describing a source/destination IP address, source/destination port number, communication protocol), temporal information indicating a time that the event occurred, or other information. The first sequence of events may be input into an artificial intelligence model to obtain a predicted state of the authorized electronic resource at the first time. For example, in response to the first event occurring, the authorized electronic resource may be classified as being in the first state. A similar process may occur when a subsequent event-a second event-occurs. In such cases, a second event sequence may include the events of the first sequence (which includes the first event) as well as the second event. The second event sequence may be input to the artificial intelligence model to obtain a predicted state of the authorized electronic resource at the second time. If the predicted state at the first time is different from the predicted state at the second time, then this indicates a state change occurred for the authorized electronic resource. Therefore, the second event can be considered to be a state change event.

Training the artificial intelligence model may be iterative, and one or more steps may be repeated one or more times and/or until a convergence condition is satisfied (e.g., a threshold training level is reached, etc.). For example, the model may be trained using a plurality of snapshots, each snapshot corresponding to a different time during the lifetime of the authorized electronic resource and each snapshot corresponding to different network data.

FIG. 1 shows an illustrative diagram of an example system 100 used to train an artificial intelligence model to perform a task related to detecting adverse network data access attempts, in accordance with one or more embodiments. In some embodiments, system 100 may include a computing system 102, an artificial intelligence model 122, one or more network databases 128, or other components. Computing system 102 may include one or more subsystems, such as event subsequence creation subsystem 104, state change identification subsystem 106, label assignment subsystem 108, snapshot generation subsystem 110, and model training subsystem 112. Network databases 128 may be configured to store various network data, such as event network data, electronic resource network data, state change network data, training network data, and the like, artificial intelligence models, or other information, or combinations thereof. As an example, network databases 128 may store event network data related to a large number of authorized electronic resources. These authorized electronic resources may include authorized electronic resources of one or more service providers, such as cloud-based service providers, hosting or providing access to one or more services (e.g., cloud-computing resource, network data storage services, transaction-related services, medical services, etc.). For example, an electronic resource may be an account, a webpage, a browser, an application, etc. that may provide access to digital systems, services, or platforms that enable clients (e.g., users, etc.) to access information or perform tasks. The electronic resource may be gateways to resources, may act as personalized credentials that grant permissions and facilitate interactions with systems, or may perform another function. Client devices associated with the authorized electronic resources may access these services (e.g., submitting HTTP requests, receiving content, etc.). Any given client device may be associated with one or more authorized electronic resources. Each authorized electronic resource may grant the client certain rights or permissions. These rights or permissions can demarcate which services and/or network data that client is authorized to access, operations/actions that the client has permission to execute, or other conditions.

As an example, network databases 128 may store event network data 132 and state change network data 134 relating to an authorized electronic resource 130. Event network data 132 may include a sequence of events associated with authorized electronic resource 130 over the lifetime of the authorized electronic resource (e.g., {{E1, T1}, {E2, T2}, {E3, T3}, {E4, T4}, . . . , {EN, TN}}). Each event includes contextual information describing the event (e.g., text indicating that a client logged into a mobile application associated with a service provider) as well as temporal information indicating a time that the event occurred. State change network data 134 may include the sequence of events including labels associated with each event indicating whether that event was associated with a state change (e.g., {{T1, L1}, {T3, L2}, . . . , {TN, L1}}). The state change events can include only the events with which state transitions are detected. For example, a state change event may not be detected during a period for which nothing happens relating to an authorized electronic resource. In some examples, the state change events can include representations or pointers to the corresponding event's network data paired with a label indicating the state of the authorized electronic resource based on that event. In this scenario, the state change event network data can include the representations/pointers and labels for only the state change events or it can include representations/pointers for all of the events associated with the authorized electronic resource. In some embodiments, network databases 128 may be able to be filtered for specific types of data, events, instances, etc. For example, filtering network databases 128 may include filtering all data stored on network databases 128 based on specific parameters, such as, for example, by including only data relating to state change events, while not including other data, such as data relating to an authorized electronic resource for a period during which there was no state change event.

The events may include interactions with the authorized electronic resource. For example, the events may include accessing a cloud computing service of a service provider using the authorized electronic resource. As another example, the events may include creating, suspending, closing, adjusting settings or configurations, or other electronic resource-related activities associated with the authorized electronic resource (e.g., unauthorized network data access attempts, charges relating to purchases, payment history, withdrawals or transfers of funds, opening new lines of credit, credit inquiries, closing the authorized electronic resource, etc.).

The sequence of events may include a subset of state change events. Each state change event of the subset of state change events is associated with a state change of the authorized electronic resource. For example, an authorized electronic resource may change states upon the occurrence of an event. The state change event may be, for example, an event during which the authorized electronic resource changes from paid off to having a balance, not interested in expansion of services to interested in expansion of services, not delinquent to delinquent, or not fraudulent to fraudulent. The system may also store network data relating to the subset of state change events. For example, tuples may be created corresponding to a state change event from the subset of state change events and may include a date of the state change event and a label indicating the state of the authorized electronic resource for that date. For example, state change network data 134 may include a tuple indicating that in response to Event 3, occurring at time T3, authorized electronic resource changed from being in a first computing state corresponding to label L1 to a second computing state correspond to label L2 (e.g., authorized electronic resource 130 has changed states from not delinquent to delinquent. The times may be measured and stored as a number of days since the opening of the authorized electronic resource, however other units of time may be used, such as seconds, minutes, hours, days, business weeks, seven-day periods, month-long periods, or other temporal units, or combinations thereof. Furthermore, although two labels L1 and L2 are shown, the labels may not be binary labels. For instance, authorized electronic resource 130 may be in one of a set of states, and therefore there can be more than two labels.

In some embodiments, computing system 102 may be configured to facilitate a novel and unconventional training process to train an artificial intelligence model, such as artificial intelligence model 122, to perform a task. For example, the task may be to predict a future state of an authorized electronic resource and, based on that predicted future state, determine one or more actions that may need to be performed. However, in certain scenarios, no actions may be needed.

In some embodiments, event subsequence creation subsystem 104 may be configured to randomly select a sample time from the lifetime of an authorized electronic resource. The sample time may be any time (e.g., minute, hour, day, week, etc.) during the lifetime of authorized electronic resource 130. For example, computing system 102 may randomly select a sample time, such as time T4, from the sequence of events represented by event network data 132. In some examples, event subsequence creation subsystem 104 may select multiple sample times, however for ease of explanation, a single sample time is selected. A similar process can be performed serially or in parallel if multiple sample times are selected. Furthermore, some examples may include selecting, randomly, multiple sample times from the lifetime of the authorized electronic resource, and then selecting one (or possibly more) of those randomly selected sample times.

In some embodiments, the sample time may be selected at one or more levels of granularity. For example, the sample time may be selected as a single day (i.e., selecting a 24-hour window of time), one or more hours, one or more minutes, or other amounts of time. The granularity level may be predefined or configured based on user input.

Event subsequence creation subsystem 104 may create a subsequence of events 114 from the sequence of events represented by event network data 132. Subsequence of events 114 may comprise events occurring during the lifetime of the authorized electronic resource prior to the sample time and/or including the sample time. For example, if the sample time refers to a time that an event occurred, then the subsequence of events may include events associated with the authorized electronic resource from the authorized electronic resource's creation until the time of the event (which is the sample time). For instance, in the example where sample time T4 is selected, subsequence of events 114 may include events E1-E4. However, if the sample time selected does not correspond to a time that an event occurred, then the subsequence of events may include events associated with the authorized electronic resource from the authorized electronic resource's creation until the last event that occurred prior to the sample time. For instance, if the sample time is a time between T4 and T5, then subsequence of events 114 may still include events E1-E4.

State change identification subsystem 106 may identify a proximate state change event 116. For example, proximate state change event 116 may be a state change event from the subset of state change events which occurs temporally closest to the sample time. To identify the temporally closest state change event, state change identification subsystem 106 may select a state change event which satisfies a temporal condition. Satisfying the temporal condition, in some embodiments, may include determining that an amount of time between the sample time and a corresponding state change event is less than a threshold amount of time. The temporal condition may include selecting the state change event that is temporally closest to the sample time. In some embodiments, the temporally closest state change event may include events occurring prior to the sample time or subsequent to the sample time. In some embodiments, a proximate state change event may be identified by using (O(\log n)) time. A binary search can be used to find the closest state change event to the sample time in (O(\log n)) time.

As an example, with reference to FIG. 1, if the sample time selected may be time T4, and therefore the state change event that is temporally proximate to the sample time (e.g., proximate state change event 116) may be event E4. In some embodiments, proximate state change event 116 may be represented using a tuple. The tuple may include an indication of the state change event and a time associated with the event. In some embodiments, the state change event may be represented in the tuple using the event (e.g., text representing the event that occurred) from the sequence of events, a representation of the event (e.g., an event identifier), a pointer or hyperlink to access the event, or other network data, or combinations thereof. The tuple of proximate state change event 116 may also include the label assigned to that event. For example, event E3 may include a label, L2, indicating a state of authorized electronic resource 130 in response to event E3 occurring. As mentioned above, event E3 may be a state change event, which indicates that in response to the sequentially prior event, event E2, authorized electronic resource 130 was in a different state (e.g., a different state represented by a different label, L1). In some embodiments, proximate state change event 116, as well as other elements of state change network data 134, may include aspects of event network data 132 as well as an assigned label representing state, and/or other network data.

Label assignment subsystem 108 may dynamically assign labels included in each tuple of the set of tuples, such as dynamically assigned label 118. Dynamically assigned label 118 may represent an approximate state of authorized electronic resource 130 at time T4. This approximation can serve as reference feedback for a predicted state of the authorized electronic resource at the selected sample time. Label assignment subsystem 108 may be configured to store a set of lists in which one number of the first list corresponds to one number of the second list. Label assignment subsystem 108 may store a set of lists such as a first list including labels for state change events and a second list including times that each state change event occurred. For example, the first list may include labels [1, 0, 1], respectively corresponding to state change events that occurred on days [20, 50, 85] in the lifetime of the authorized electronic resource. In this example, a first state change event, having a label “1” may correspond to Day 20 in the lifetime of the authorized electronic resource, a second event, having a label “0” may correspond to Day 50 in the lifetime of the authorized electronic resource, and a third event, having a label “1” may correspond to Day 85 in the lifetime of the authorized electronic resource). In this example, the authorized electronic resource has changed states on Day 20 and has been assigned a label (e.g., “1”). On Day 50, the authorized electronic resource changes states, and is assigned another label (e.g., “0”). On Day 85, the authorized electronic resource changes states again, and is assigned another label (e.g., “1”). In some cases, the label may be assigned to events occurring during the period of time until a subsequent label change. Using the previous example, the label “1” from Day 20 may be assigned, as a label, to each event and/or unit of time from that day until a subsequent state change event (e.g., Day 49), when the label changes (e.g., from “1” to “0”). Similarly, the label assigned to Day 50, which corresponds to a state transition event, may be assigned to each event and/or unit of time from Day 50 to the next state transition event (e.g., occurring at Day 84). In the previous example, the label assigned to events and/or units of time may refer to assigning labels to any events that occur between two state change events. As it may be computationally expensive to determine a state of the authorized electronic resource for each event, the assignment of the most recent state change event's label may serve as a proxy label for reference feedback when training artificial intelligence model 122. In some cases, where an event does not occur between two state change events, but one or more units of time elapse (e.g., one or more hours, one or more days, etc.), the label assigned to the most proximate state change event may be assigned to each unit of time.

For example, the authorized electronic resource of a client who misses a payment may become delinquent on Day 20, but if the client makes the payment on Day 50, the authorized electronic resource may become no longer delinquent on Day 50.

Electronic resource snapshot generation subsystem 110 may generate one or more electronic resource snapshots, such as electronic resource snapshot 120. Electronic resource snapshot 120 may include subsequence of events 114, as well as a label. For example, the label may correspond to dynamically assigned label 118. Continuing the previous example, in which the tuples stored for an authorized electronic resource include labels for indicating state change events (e.g., [1, 0, 1]) and times associated with those state change events (e.g., days [20, 50, 85],” if the sample time is Day 45, proximate state change event 116 may be on Day 20. As such, Day 45 may be assigned the same label (e.g., “1”). Furthermore, electronic resource snapshot generation subsystem 110 may generate electronic resource snapshot 120 including subsequence of events 114 and dynamically assigned label 118. A label may not be available for every point in time, and as such, dynamic assignment of labels is used to interpolate what a label is at a given point in time.

System 100 may also include artificial intelligence model 122. Although artificial intelligence model 122 is depicted as being external to computing system 102, persons of ordinary skill in the art will recognize that artificial intelligence model 122 may be implemented using hardware components of computing system 102. Alternatively, or additionally, artificial intelligence model 122 may be accessed using computing system 102. For example, model training subsystem 112 may utilize one or more APIs to communicate inputs to artificial intelligence model 122.

Artificial intelligence model 122 may utilize a unique training architecture. For example, to predict the likelihood of an adverse event occurring for an authorized electronic resource, without using an exponentially large amount of network data, the system may use a training architecture in which status changes for an authorized electronic resource are tracked using labels assigned to the time of each status change. For example, artificial intelligence model 122 may be trained on electronic resource snapshots of an authorized electronic resource. As detailed above, the electronic resource snapshot (e.g., electronic resource snapshot 120) can include a label indicating a predicted state of the authorized electronic resource (e.g., authorized electronic resource 130) at a particular future time. The label may be assigned by identifying the most temporally proximate status change event (e.g., proximate state change event 116) for the authorized electronic resource and assigning the label (e.g., dynamically assigned label 118) to the subsequence of events (e.g., subsequence of events 114). The electronic resource snapshot may also include the subsequence of events (e.g., subsequence of events 114) including the events associated with the authorized electronic resource that occur during the lifetime of the authorized electronic resource up to and/or including the sample time.

In some embodiments, model training subsystem 112 may be configured to input electronic resource snapshot 120 to artificial intelligence model 122. In some examples, model training subsystem 112 may provide the subsequence of events (e.g., subsequence of events 114) and may prevent inputting the dynamically assigned label (e.g., dynamically assigned label 118) from being input to artificial intelligence model 122. In some examples, electronic resource snapshot 120 may be input to artificial intelligence model 122 with the dynamically assigned label masked.

Model training subsystem 112 may be configured to receive a predicted label (e.g., predicted label 124) output by artificial intelligence model 122. The predicted label can indicate a state that authorized electronic resource 130 is predicted to be in based on the subsequence of events input to artificial intelligence model 122. For example, artificial intelligence model 122 may output a predicted future state score indicating whether an authorized electronic resource will be in a particular computing state at a future time. Model training subsystem 112 may receive, in addition to the predicted label output by artificial intelligence model 122, the dynamically assigned label. Model training subsystem 112 may execute one or more model optimization algorithms (e.g., Adam optimizer, stochastic gradient descent, and the like) to determine parameter adjustments 126. Parameter adjustments 126 may include instructions to cause one or more parameters of artificial intelligence model 122 to be adjusted to minimize a loss computed using the predicted label (e.g., predicted label 124) and the dynamically assigned label (e.g., dynamically assigned label 118). Model training subsystem 112 may generate parameter adjustments 126 for artificial intelligence model 122 to help improve an accuracy of artificial intelligence model 122 by minimizing the loss, which describes the difference between the model's predictions (e.g., future state of the authorized electronic resource) and the reference feedback (the dynamically assigned label). Artificial intelligence model 122 may be tested and validated to ensure that artificial intelligence model 122 is operating to make the most accurate predictions possible.

In some embodiments, artificial intelligence model 122 may be trained to predict a future state of a given authorized electronic resource for a particular future time based on the training network data. During each iteration of the training process, artificial intelligence model 122 may predict a future state of a given authorized electronic resource. As an example, artificial intelligence model 122 may predict a future state of authorized electronic resource 130 at time T4, while proximate state change event 116 may have occurred at time T3. Therefore, when predicting the future state of authorized electronic resource 130, artificial intelligence model 122 predicts the state of authorized electronic resource 130 at a future time TF, where TF equals the difference of T4 and T3. During each iteration, however, the value for TF may vary, which can allow the model to learn how far in the future states can be predicted.

As mentioned above, computing system 102 may communicate with network databases 128. Network databases 128 may provide and receive network data to and from computing system 102. Network databases 128 may store network data relating to, for example, a plurality of authorized electronic resources such as authorized electronic resource 130. For example, network databases 128 may store event network data and state change network data for authorized electronic resource 130. Network databases 128 may provide network data to be used in the processes of any of the subsystems of computing system 102, such as event subsequence creation subsystem 104, state change identification subsystem 106, label assignment subsystem 108, snapshot generation subsystem 110, and model training subsystem 112.

Additionally, network databases 128 may include and/or store other network databases. As shown in FIG. 2A, for example, network databases 128 may include event network database 202, electronic resource network database 204, state change network database 206, training network data network database 208, and model network database 210. Model network database 210 may store the artificial intelligence models network data relating to the operation of one or more artificial intelligence models. In some embodiments, event network database 202, electronic resource network database 204, state change network database 206, training network data network database 208, and model network database 210 may represent logical portions of memory used to store network data used for various aspects and operations of computing system 102.

For example, FIG. 2B depicts an exemplary embodiment of event network database 202. Event network database 202 may store event network data 212-1 relating to authorized electronic resource 214-1. For example, event network database 202 may store network data relating to a plurality of authorized electronic resources, which may include authorized electronic resource 214-1 and one or more other authorized electronic resources. Event network data 212-1 may include the events that have occurred during the lifetime of authorized electronic resource 212-1. For example, event network data 212-1 may include every interaction an authorized electronic resource has with a service or product of a service provider system. In the illustrated example, event network data 212-1 for authorized electronic resource 214-1 may include: 1) A set of events (i.e., Events 1-M); 2) Event information (i.e., Event_Info_1-M) describing the event; 3) Temporal information (i.e., T1-TM) indicating a time the event occurred; 4) A label indicating a state of the electronic resource at the time of the event, or other network data.

FIG. 2C shows an exemplary embodiment of electronic resource network database 204. Electronic resource network database 204 may store network data relating to a plurality of authorized electronic resources (e.g., authorized electronic resource 214-1 thru 214). For example, electronic resource network database 204 may store client electronic resource information such as name, date of birth, etc., electronic resource-identifying information such as electronic resource type and a value associated with the electronic resource, available services, notices, etc. In the example of FIG. 2C, electronic resource network database 204 may store 1) Electronic resource ID (e.g., Electronic resource_ID_1-N) and 2) Available Services (e.g., S1, S2, S3, S4, etc.). For example, network data stored by electronic resource network database 204 may include available services, such as mobile application electronic resource access, facial recognition, card replacement, resource allocations, resource consumption, transactions, etc.

Turning now to FIG. 2D, an exemplary embodiment of state change network database 206 is shown. State change network database 206 may store network data relating to state changes for an authorized electronic resource. For example, state change network database 206 may store network data relating to when an authorized electronic resource changes states between open and closed, good standing and poor standing, not delinquent and delinquent, not fraudulent and fraudulent, etc. In the example of FIG. 2D, state change network data for an authorized electronic resource includes: 1) State Change Event ID (i.e., 1-N); 2) Event ID (i.e., Event 1-M); 3) Temporal information (i.e., T1-TN) indicating a time the event occurred; and 4) A label indicating a state of the electronic resource at the time of the event. In other embodiments, state change network data may include other network data. For example, state change network data may include prior state information and/or current state information.

FIG. 2E depicts an exemplary embodiment of training network data network database 208. Training network data network database 208 may store one or more electronic resource snapshots to be used when training an artificial intelligence model, such as electronic resource snapshot 218-1. For example, training network data network database 208 may store network data relating to authorized electronic resources, results output by the artificial intelligence model, etc. In the example of FIG. 2E, electronic resource snapshot 218-1 may include an Electronic resource ID (i.e., Electronic resource_ID_1) and a Sample Time (e.g., T4), as well as 1) A subsequence (i.e., Event 1-4); 2) A 4) A label indicating a state of the electronic resource at the time of the event; and 3) A dynamically assigned label. For example, electronic resource snapshot 218-1 may indicate a sample time (e.g., time T4) used to create the subsequence. Event 3 is temporally most proximate to Event 4. Event 3 also has a previously determined label of 1, corresponding to an occurrence of the authorized electronic resource changing from one state to another. Therefore, the dynamically assigned label (e.g., the reference label to be used when training the model for the subsequence of events), will be the label of 1 of Event 3.

FIG. 3 shows an illustrative diagram of an example system leveraging a trained artificial intelligence model to detect and prevent an adverse network data access attempt, in accordance with one or more embodiments. The artificial intelligence model, once trained, can be leveraged to detect and prevent adverse access to secure network data. Once the artificial intelligence model is trained, the artificial intelligence model can be implemented to make predictions. System 300 as shown in FIG. 3 further includes client device 302. Client device 302 may be configured to communicate with one or more services 304 (i.e., Service 304-1-N), for example, via a request to interact with service 304. Services 304 may be cloud-based services, whereby clients can access these services via an API. Services 304 may include access to an electronic resource, access to a storage platform storing network data such as photographs, access to an electronic resource on a shopping platform, access to records such as student or medical records, etc.

In some embodiments, client device 302 may submit one or more requests to services 304. For example, client device 302 may submit a request 306 to access an authorized electronic resource, where private network data associated with the authorized electronic resource may be stored in a cloud-based network database via one of services 304. Request 306 may include a request to perform additional or alternative actions using the same or different services. For example, client device 302 may submit a request to open a new electronic resource, withdraw or transfer resources, execute a transaction, and the like. In some cases, requests to interact with service 304 may result in candidate event 308. For example, candidate event 308 may include an adverse event such as a suspicious event, a possible fraudulent event, an event which negatively impacts the authorized electronic resource or the client associated with the authorized electronic resource, etc. Candidate event 308 may be detected by system 300 based on several factors or parameters. For example, candidate event 308 may be detected by system 300 based on standard practices for an authorized electronic resource, unlikely actions for an authorized electronic resource, environmental factors, events within the lifetime of an authorized electronic resource, etc.

In some embodiments, candidate event 308 may be received by computing system 310 from services 304. For example, computing system 310 may be substantially the same as computing system 102. Computing system 310 may retrieve event network data 312 relating to and/or including candidate event 308 from event network database 202 and may provide event network data 312 to trained artificial intelligence model 314 (e.g., an artificial intelligence model which has been previously trained according to the procedures described herein). The artificial intelligence model, once trained using the novel training process, can be leveraged to detect and prevent adverse access to secure network data. Once the artificial intelligence model is trained using the novel training process, the artificial intelligence model can be implemented to make predictions. Event network data 312 may relate to candidate event 308, or may be retrieved according to other factors or parameters, such as an amount of time, a location, etc. Artificial intelligence model 314 may, in response to event network data 312 being provided as an input, generate and output, to computing system 310, predicted future state 316. Predicted future state 316 may include a predicted future state score which may be indicative of a likelihood that candidate event 308 is an adverse event. Computing system 310 may communicate with service availability modification subsystem 318, for example, to communicate predicted future state 316.

Service availability modification subsystem 318 may be configured to modify, restrict, cancel, enable, or expand access to one or more services, such as services 304, of an authorized electronic resource. Based on the predicted future state score of predicted future state 316 being greater than a threshold score, service availability modification subsystem 318 may disable one or more services of the authorized electronic resource, thus preventing possible and/or further harm from the adverse event.

For example, client device 302 may be in the possession of an unauthorized user. The unauthorized user may attempt to access the authorized electronic resource (e.g., request to interact with service 304) by logging into the electronic resource using facial recognition. The attempt to access the authorized electronic resource will fail, triggering candidate event 308. Trained artificial intelligence model 314 may output predicted future state 316 indicating a likelihood that candidate event 308 is an adverse event. Accordingly, service availability modification subsystem 318 may disable login by facial recognition for the authorized electronic resource. Further, service availability modification subsystem 318 may include the ability to generate one or more alerts 320 to client device 302. For example, alert 320 may include a notification of the unauthorized attempt to access the authorized electronic resource, an instruction to log in using a password, steps to reset the password of the authorized electronic resource, etc.

As an example, candidate event 308 may be a new line of credit associated with the authorized electronic resource being opened, and the sequence of events may include events leading up to and including the opening of the new line of credit, for example, applying for one or more lines of credit, credit card usage, payment history, etc. System 300 may input the retrieved event network data into the trained artificial intelligence model 314 and trained artificial intelligence model 314 may output a predicted future state score for the authorized electronic resource within a predefined amount of time of candidate event 308 being detected. The predicted future state score may indicate whether candidate event 308 corresponds to a potential adverse event if the predicted future state score is greater than a threshold state score indicative of candidate event 308 corresponding to a potential adverse event being predicted to occur within the predefined amount of time of candidate event 308. Accordingly, the system may disable one or more services of the authorized electronic resource. For example, the predicted future state score may indicate that the opening of a new line of credit is a potential adverse event given the electronic resource history for a particular client. For example, opening a new line of credit may be considered suspicious for the client based on one or more factors such as number of credit inquiries or applications for lines of credit, balances on credit electronic resources, payment history, etc., indicating that the opening of the new line of credit is a fraudulent event. System 300 may disable one or more services of the authorized electronic resource, thereby preventing possible and/or further harm from the potential adverse event. For example, the authorized electronic resource may be frozen, preventing use of the lines of credit, until the client can verify any activity related to the authorized electronic resource, such as the opening of the new line of credit. If an authorized electronic resource is able to be verified, services of the authorized electronic resource may be expanded, opened, or renewed.

As another example, candidate event 308 may be an event during which a client attempts to access an area or related webpage or service of the authorized electronic resource that the client has not previously accessed. Based on network data relating to the event, system 300 may predict a future state of the authorized electronic resource which includes the client expanding upon known services of the authorized electronic resource. System 300 may provide alert 320 to the client, offering information, access, permission, etc. for the client to pursue expansion of services.

FIG. 4 shows illustrative components for a system 400 that can be used to prevent adverse network data access, in accordance with one or more embodiments. For example, FIG. 4 may show illustrative components for preventing adverse network data access of an authorized electronic resource using trained artificial intelligence models. As shown in FIG. 4, system 400 may include mobile device 402 and client terminal 404 for use by a client (e.g., a customer, a user, an authorized electronic resource holder, etc.). While shown as a smartphone and personal computer, respectively, in FIG. 4, it should be noted that mobile device 402 and client terminal 404 may be any computing device, including, but not limited to, a laptop computer, a tablet computer, a hand-held computer, and other computer equipment (e.g., a server), including “smart,” wireless, wearable, and/or mobile devices. FIG. 4 also includes cloud components 406. Cloud components 406 may alternatively be any computing device as described above, and may include any type of mobile terminal, fixed terminal, or other device. For example, cloud components 406 may be implemented as a cloud computing system and may feature one or more component devices. It should also be noted that system 400 is not limited to three devices. Clients may, for instance, utilize one or more devices to interact with one another, one or more servers, or other components of system 400. It should be noted, that, while one or more operations are described herein as being performed by particular components of system 400, these operations may, in some embodiments, be performed by other components of system 400. As an example, while one or more operations are described herein as being performed by components of mobile device 402, these operations may, in some embodiments, be performed by components of cloud components 406. In some embodiments, the various computers and systems described herein may include one or more computing devices that are programmed to perform the described functions. Additionally, or alternatively, multiple clients may interact with system 400 and/or one or more components of system 400. For example, in one embodiment, a first client and a second client may interact with system 400 using two different components.

With respect to the components of mobile device 402, client terminal 404, and cloud components 406, each of these devices may receive content and network data via input/output (hereinafter “I/O”) paths. Each of these devices may also include processors and/or control circuitry to send and receive commands, requests, and other suitable network data using the I/O paths. The control circuitry may comprise any suitable processing, storage, and/or input/output circuitry. Each of these devices may also include a client input interface and/or client output interface (e.g., a display) for use in receiving and displaying network data. For example, as shown in FIG. 4, both mobile device 402 and client terminal 404 include a display upon which to display network data (e.g., conversational response, queries, and/or notifications).

Additionally, as mobile device 402 and client terminal 404 may be touchscreen smartphones, these displays also act as client input interfaces. It should be noted that in some embodiments, the devices may have neither client input interfaces nor displays, and may instead receive and display content using another device (e.g., a dedicated display device such as a computer screen, and/or a dedicated input device such as a remote control, mouse, voice input, etc.). Additionally, the devices in system 400 may run an application (or another suitable program). The application may cause the processors and/or control circuitry to perform operations related to generating dynamic conversational replies, queries, and/or notifications.

Each of these devices may also include electronic storage. The electronic storage may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 4 also includes communication paths 408, 410, and 412. Communication paths 408, 410, and 412 may include the Internet, a mobile phone network, a mobile voice or network data network (e.g., a 5G or LTE network), a cable network, a public switched telephone network, or other types of communications networks or combinations of communications networks. Communication paths 408, 410, and 412 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 406 may include model 414 (e.g., artificial intelligence model 122), which may be a machine learning model, artificial intelligence model, transformer model, etc. (which may be referred collectively as “models” herein). Model 414 may take inputs 416 (e.g., electronic resource snapshots 120, parameter adjustments 126, event network data 312, etc.) and provide outputs 418 (e.g., predicted label 124, predicted future state 316, etc.). Inputs 416 may include multiple network datasets, such as a training network dataset, a test network dataset, a client network dataset, an event network dataset, etc. Each of the plurality of network datasets (e.g., inputs 416) may include network data subsets related to client network data, event network data, electronic resource state change network data, etc. In some embodiments, outputs 418 may be fed back to model 414 as input to train model 414 (e.g., alone or in conjunction with other reference feedback information).

In a variety of embodiments, model 414 may update its configurations (e.g., weights, biases, or other parameters) based on an assessment of the predictions (e.g., outputs 418) and reference feedback information (e.g., prediction accuracy, reference labels, or other information). In a variety of embodiments, where model 414 is a neural network, connection weights may be adjusted to reconcile differences between the prediction of the neural network and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 414 may be trained to generate better predictions.

In some embodiments, model 414 may include an artificial neural network. In such embodiments, model 414 may include an input layer and one or more hidden layers. Each neural unit of model 414 may be connected with many other neural units of model 414. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 414 may be self-learning and trained, rather than explicitly programmed, and can perform significantly better in certain areas of problem solving, as compared to traditional computer programs. During training, an output layer of model 414 may correspond to a classification of model 414, and an input known to correspond to that classification may be input into an input layer of model 414 during training. During testing, an input without a known classification may be input into the input layer, and a determined classification may be output. Model 414 can be tested and validated prior to deployment.

In some embodiments, model 414 may include multiple layers (e.g., where a signal path traverses from front layers to back layers). In some embodiments, back propagation techniques may be utilized by model 414 where forward stimulation is used to reset weights on the “front” neural units. In some embodiments, stimulation and inhibition for model 414 may be more free-flowing, with connections interacting in a more chaotic and complex fashion. During testing, an output layer of model 414 may indicate whether or not a given input corresponds to a classification of model 414 (e.g., client relationship matrices, contextually relevant summaries, etc.).

In some embodiments, the model (e.g., model 414) may automatically perform actions based on outputs 418. In some embodiments, the model (e.g., model 414) may not perform any actions. The output of the model (e.g., model 414) may be used to predict the likelihood of an adverse event for an authorized electronic resource of a client.

FIG. 5 shows a flowchart of an example process 500 involved in preventing adverse network data access to secure network data, in accordance with one or more embodiments. For example, the system may use process 500 (e.g., as implemented on one or more system components described above, such as computing system 310 of FIG. 3) in order to prevent adverse access to secure network data based on a state of an authorized electronic resource predicted by an artificial intelligence model.

At step 502, the activity of an authorized electronic resource may be monitored. The activity of the authorized electronic resource may include opening an electronic resource, accessing an electronic resource, making a transaction, requesting a new line of credit, making a withdrawal or transfer, closing an electronic resource, etc. the system may store network data relating to the monitoring of the authorized electronic resource.

At step 504, process 500 may include detecting (e.g., using one or more components described above) a candidate event (e.g., candidate event 308, etc.) associated with the authorized electronic resource. The candidate event may be any event corresponding to an authorized electronic resource such as an attempt to access the electronic resource, a transaction, a withdrawal or transfer, etc. For example, the candidate event may be a potential adverse event that may have an effect on the authorized electronic resource. Detecting the candidate event associated with the authorized electronic resource may include receiving, from a telecommunication device (e.g., mobile device 402 and/or client terminal 404), a notification of a detected interaction with the authorized electronic resource.

At step 506, process 500 (e.g., using one or more components described above) retrieves event network data (e.g., from event network database 202, etc.) comprising a sequence of events associated with the authorized electronic resource including the candidate event (e.g., event network data 312, etc.). For example, the sequence of events may be a series of events leading up to and including the candidate event. Retrieving the event network data may include accessing an event network database storing event network data for a plurality of authorized electronic resources and retrieving events occurring during a lifetime of the authorized electronic resource prior to the candidate event.

At step 508, process 500 (e.g., using one or more components described above) inputs the event network data into a trained artificial intelligence model to obtain a predicted future state for the authorized electronic resource. The predicted future state may include a likelihood of an adverse event being detected for the authorized electronic resource.

At step 510, process 500 (e.g., using one or more components described above) determines whether a predicted future state score (e.g., predicted future state 316, etc.) is greater than a threshold state score. The predicted future state score being greater than a threshold state score may be indicative of the candidate event corresponding to a potential adverse event that may have an effect on the authorized electronic resource.

At step 512, process 500 (e.g., using one or more components described above) disables one or more services of the authorized electronic resource based on the predicted future state. For example, disabling the one or more services of the authorized electronic resource may be based on a predicted future state score being greater than a threshold state score indicative of the candidate event corresponding to a potential adverse event. Disabling the one or more services of the authorized electronic resource may include, for example, preventing access to secure network data stored by the authorized electronic resource and/or generating an alert transmitted to a known client device (e.g., mobile device 402 and/or client terminal 404) associated with the authorized electronic resource.

FIGS. 6A-6B show a flowchart of an example process 600 involved in training an artificial intelligence model (e.g., artificial intelligence model 122, etc.) to prevent adverse network data access to secure network data, in accordance with one or more embodiments. For example, process 600 (e.g., as implemented on one or more system components described above) may be used in order to train an artificial intelligence model to prevent adverse access to secure network data based on a state of an authorized electronic resource (e.g., authorized electronic resource 130, etc.) predicted by the artificial intelligence model (e.g., predicted label 124, etc.). For example, process 600 may be used with process 500.

At step 602, process 600 (e.g., using one or more components described above) retrieves state change network data (e.g., state change network data 134, etc.) associated with a plurality of authorized electronic resources. For example, the state change network data may be stored on a network database of the system (e.g., network databases 128, etc.). The state change network data may include network data relating to state changes for an authorized electronic resource.

At step 604, process 600 (e.g., using one or more components described above) randomly selects an authorized electronic resource from the plurality of authorized electronic resources. At step 606, process 600 (e.g., using one or more components described above) randomly selects a sample time (e.g., electronic resource snapshot 120, etc.) from the lifetime of the randomly selected authorized electronic resource. For example, the sample time may be a day during the lifetime of the randomly selected authorized electronic resource. At step 608, process 600 (e.g., using one or more components described above) creates a subsequence of events from a sequence of events occurring during the lifetime of the randomly selected authorized electronic resource, prior to and/or including the sample time. For example, the subsequence of events may be a snapshot of the authorized electronic resource taken at the time of the sample time.

At step 610, process 600 (e.g., using one or more components described above) identifies a state change event satisfying a temporal condition (e.g., proximate state change event 116, etc.). For example, the state change event satisfying the temporal condition may be an event temporally closest to the sample time during which a state of the authorized electronic resource changed. The temporal condition being satisfied may include an amount of time between the state change event and the snapshot of the authorized electronic resource being less than a threshold amount of time. For example, the temporally closest state change event may be an event in which the authorized electronic resource changes states between open and closed, good standing and poor standing, not delinquent and delinquent, not fraudulent and fraudulent, etc.

At step 612, process 600 (e.g., using one or more components described above) assigns a label associated with the identified state change to the snapshot of the authorized electronic resource including the subsequence of events e.g., subsequence of events 114, etc.). For example, the label may be a binary label such as 1 or 0, or may be another label.

At step 614, process 600 (e.g., using one or more components described above) inputs the subsequence of events into an artificial intelligence model to generate a predicted label (e.g., predicted label 124, etc.) for the subsequence of events. For example, the predicted label may correspond to a predicted future state score for the authorized electronic resource and may indicate a likelihood of an adverse event being detected for the authorized electronic resource.

At step 616, process 600 (e.g., using one or more components described above) computes a loss based on the predicted label and the assigned label in order to determine whether a convergence condition has been satisfied. At step 618, process 600 (e.g., using one or more components described above) determines whether the convergence condition has been satisfied. For example, the convergence condition may be satisfied when the computed loss between the predicted label and the assigned label is less than a threshold, when an accurate prediction has been made a certain number of times in a row, when a predefined number (or all) of the authorized electronic resources have been selected for creating snapshots, etc.

At step 620, upon a determination that the convergence condition has not been satisfied, process 600 (e.g., using one or more components described above) adjusts one or more parameters of the artificial intelligence model. For example, at step 622, process 600 (e.g., using one or more components described above) may return to step 506, retrieving new event network data comprising a sequence of events associated with the authorized electronic resource including the candidate event.

Training the artificial intelligence model may be iterative, and the aforementioned steps may be repeated one or more times and/or until the convergence condition is satisfied (e.g., a threshold training level is reached, etc.). At step 624, upon a determination that the convergence condition has been satisfied, process 600 (e.g., using one or more components described above) stores the trained artificial intelligence model for future use.

In some embodiments, process 500 and process 600 (e.g., using one or more components described above) may include one or more additional steps. For example, process 500 may include storing, using a state change network database, state change network data associated with an authorized electronic resource. The state change network data may correspond to a subset of state change events from a sequence of events associated with the authorized electronic resource. Each state change event in the subset of state change events may be associated with a state change of the authorized electronic resource. Storing the state change network data may include storing a set of tuples, where each tuple of the set of tuples corresponds to a state change event from the subset of state change events and includes a date of the state change event and a label indicating a state of the authorized electronic resource for that date.

It is contemplated that the steps or descriptions of FIGS. 5-6B may be used with any other embodiment of this disclosure. In addition, the steps and descriptions described in relation to FIGS. 5-6B may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIGS. 5-6B.

The above-described embodiments of the present disclosure are presented for purposes of illustration and not limitation, and the present disclosure is limited only by the claims that follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for preventing adverse network data access to secure network data.
2. The method of the preceding embodiment, further comprising: detecting a candidate event associated with an authorized electronic resource; retrieving event network data comprising a sequence of events associated with the authorized electronic resource including the candidate event; inputting the event network data into a trained artificial intelligence model to obtain a predicted future state for the authorized electronic resource, wherein the trained artificial intelligence model is trained
by: randomly taking one or more authorized electronic resource snapshots of the authorized electronic resource; identifying a first state change event from a subset of state change events satisfying a temporal condition indicating that the first state change event occurred temporally closest to the authorized electronic resource snapshot, wherein the temporal condition being satisfied comprises an amount of time between the first state change event and the authorized electronic resource snapshot being less than a threshold amount of time; and dynamically assigning a first label associated with the first state change event to a subsequence of events comprising events occurring during a lifetime of the authorized electronic resource prior to the authorized electronic resource snapshot; and disabling, based on the predicted future state, one or more services of the authorized electronic resource.
3. The method of any one of the preceding embodiments, wherein disabling, based on the predicted future state, the one or more services of the authorized electronic resource comprises disabling the one or more services of the authorized electronic resource based on a predicted future state score of the predicted future state being greater than a threshold state score indicative of the candidate event corresponding to a potential adverse event.
4. The method of any one of the preceding embodiments, wherein detecting the candidate event associated with the authorized electronic resource comprises receiving, from a telecommunication device, a notification of a detected interaction with the authorized electronic resource; and detecting the candidate event based on the detected interaction.
5. The method of any one of the preceding embodiments, wherein retrieving the event network data comprises accessing an event network database storing event network data for authorized electronic resources to retrieve events occurring during a lifetime of the authorized electronic resource prior to the candidate event; and determining the event network data by filtering the event network database for the authorized electronic resources.
6. The method of any one of the preceding embodiments, further comprising storing, using an electronic resource network database, electronic resource network data for a plurality of authorized electronic resources, the plurality of authorized electronic resources comprising the authorized electronic resource; and determining the subset of state change events from the electronic resource network data for each of the plurality of authorized electronic resources.
7. The method of the preceding embodiment, further comprising: storing, using a state change network database, state change network data associated with the authorized electronic resource, wherein the state change network data corresponds to a subset of state change events from a sequence of events associated with the authorized electronic resource, wherein each state change event in the subset of state change events is associated with a state change of the authorized electronic resource.
8. The method of any one of the preceding embodiments, wherein storing the state change network data comprises storing a set of tuples, each tuple of the set of tuples corresponding to a state change event from the subset of state change events and including a date of the state change event and a label indicating a state of the authorized electronic resource for that date.
9. The method of any one of the preceding embodiments, wherein disabling, based on the predicted future state, the one or more services of the authorized electronic resource comprises: preventing access to secure network data associated with the authorized electronic resource; and generating and transmitting, to a client device associated with the authorized electronic resource, an alert indicating that the secure network data was prevented from being accessed.
10. The method of any one of the preceding embodiments, further comprising training, using the authorized electronic resource snapshots and the dynamically assigned labels determined based on the authorized electronic resource snapshots, an artificial intelligence model to obtain the trained artificial intelligence model, wherein the predicted future state obtained by trained artificial intelligence model comprises a likelihood of an adverse event associated with the authorized electronic resource being detected.
11. The method of any one of the preceding embodiments, further comprising: retrieving state change network data associated with a plurality of authorized electronic resources, the state change network data comprising a date of an event associated with a state change of a corresponding authorized electronic resource and a label indicating a state of the corresponding authorized electronic resource for that date, wherein the authorized electronic resource snapshots are derived based on the state change network data; and generating, using the state change network data, the authorized electronic resource snapshots and the dynamically assigned labels determined based on the authorized electronic resource snapshots respectively associated with the plurality of authorized electronic resources.
12. The method of the preceding embodiment, wherein generating the authorized electronic resource snapshots and the dynamically assigned labels determined based on the authorized electronic resource snapshots comprises: randomly selecting a first authorized electronic resource of the plurality of authorized electronic resources; randomly selecting a sample time from a first lifetime of the first authorized electronic resource for a first authorized electronic resource snapshot of the first authorized electronic resource, wherein a first sequence of events associated with the first authorized electronic resource occur during the first lifetime; creating a first subsequence of events from the first sequence of events comprising events occurring during the first lifetime prior to the sample time, wherein the authorized electronic resource snapshots comprise the first subsequence of events; inputting the first subsequence of events into the trained artificial intelligence model to generate a first predicted label for the first subsequence of events indicating a likelihood of an adverse event associated with the first authorized electronic resource being detected; and adjusting one or more parameters of the artificial intelligence model based on a loss computed using the first predicted label and a dynamically assigned label for the first subsequence of events.
13. The method of the preceding embodiment, wherein adjusting one or more parameters of the artificial intelligence model based on the loss computed using the first predicted label and the dynamically assigned label for the first subsequence of events further comprises: retrieving a convergence condition; determining a condition of the artificial intelligence model based on adjusting one or more parameters of the artificial intelligence model based on a loss computed using the first predicted label and the dynamically assigned label for the first subsequence of events; and comparing the convergence condition to the condition.
14. The method of the preceding embodiment, wherein comparing the convergence condition to the condition comprises at least one of: determining that a computed loss is less than a threshold loss indicative of the artificial intelligence model being trained; determining that a threshold number of matches have been made between predicted labels and dynamically assigned labels; or determining that a predefined number of authorized electronic resources or a predefined subset of authorized electronic resources of the plurality of authorized electronic resources have been selected.
15. The method of any one of the preceding embodiments, wherein determining the dynamically assigned labels for the authorized electronic resource snapshots comprises: identifying, prior to inputting the first subsequence of events into the trained artificial intelligence model to generate the first predicted label for the first subsequence of events, a first state change event from a subset of state change events satisfying a temporal condition indicating that the first state change event occurred temporally closest to the sample time; and assigning a first label associated with the first state change event to the first subsequence of events, wherein the dynamically assigned labels comprise the first label associated with the first state change event.
16. The method of the preceding embodiment, wherein satisfying the temporal condition comprises: determining an amount of time between the first state change event and the first authorized electronic resource snapshot; and determining the amount of time between the first state change event and the first authorized electronic resource snapshot is less than a threshold amount of time.
17. One or more non-transitory, computer-readable mediums storing instructions that, when executed by a network data processing apparatus, cause the network data processing apparatus to perform operations comprising those of any of embodiments 1-16.
18. A system comprising one or more processors; and memory storing instructions that, when executed by the processors, cause the processors to effectuate operations comprising those of any of embodiments 1-16.
19. A system comprising means for performing any of embodiments 1-16.

What is claimed is:

1. A system for preventing adverse network data access to secure network data, comprising:
cloud-based memory configured to store, for each authorized electronic resource of a plurality of authorized electronic resources, state change network data corresponding to a subset of state change events from a sequence of events associated with the authorized electronic resource, wherein the sequence of events comprises interactions with the authorized electronic resource occurring over a lifetime of the authorized electronic resource, wherein each state change event in the subset of state change events is associated with a state change of the authorized electronic resource, wherein the state change network data comprises a set of tuples, each tuple of the set of tuples corresponding to a state change event from the subset of state change events and including a date of the state change event and a label indicating a state of the authorized electronic resource for that date; and
cloud-based control circuitry configured to:
train a transformer model to predict a likelihood of an adverse event being detected for an authorized electronic resource with a service provider system within a predefined amount of time, wherein to train the transformer model, the cloud-based control circuitry is configured, for each authorized electronic resource of the plurality of authorized electronic resources, to iteratively:
randomly select a sample time from the lifetime of the authorized electronic resource;
create a subsequence of events from the sequence of events associated with the authorized electronic resource comprising events occurring during the lifetime of the authorized electronic resource prior to the sample time;
identify a first state change event from the subset of state change events satisfying a temporal condition indicating that the first state change event occurred temporally closest to the sample time, wherein the temporal condition being satisfied comprises an amount of time between the first state change event and the sample time being less than a threshold amount of time;
assign a first label associated with the first state change event to the subsequence of events; and
input the subsequence of events into a transformer model to generate a predicted label for the subsequence of events indicating a likelihood of the adverse event being detected for the authorized electronic resource within the predefined amount of time of the sample time; and
adjust one or more parameters of the transformer model based on a loss computed using the predicted label and the first label;
detect a candidate event associated with a first authorized electronic resource of the plurality of authorized electronic resources;
retrieve event network data comprising a sequence of events associated with the first authorized electronic resource including the candidate event;
input the event network data into the trained transformer model to obtain a first predicted future state score for the authorized electronic resource, the first predicted future state score indicating a likelihood of the adverse event being detected within the predefined amount of time of the candidate event; and
responsive to determining that the first predicted future state score is greater than a threshold state score indicative of the adverse event being predicted to occur within the predefined amount of time of the candidate event, disable one or more services of the first authorized electronic resource.

2. A method, implemented using one or more processors of a computing system, comprising:
detecting a candidate event associated with an authorized electronic resource;
retrieving event network data comprising a sequence of events associated with the authorized electronic resource including the candidate event;
inputting the event network data into a trained artificial intelligence model to obtain a predicted future state of the authorized electronic resource, wherein the trained artificial intelligence model is trained by:
randomly taking one or more authorized electronic resource snapshots of the authorized electronic resource;
identifying a first state change event from a subset of state change events satisfying a temporal condition indicating that the first state change event occurred temporally closest to the authorized electronic resource snapshot, wherein the temporal condition being satisfied comprises an amount of time between the first state change event and the authorized electronic resource snapshot being less than a threshold amount of time; and
dynamically assigning a first label associated with the first state change event to a subsequence of events comprising events occurring during a lifetime of the authorized electronic resource prior to the authorized electronic resource snapshot; and
disabling, based on the predicted future state, one or more services of the authorized electronic resource.

3. The method of claim 2, wherein disabling, based on the predicted future state, the one or more services of the authorized electronic resource comprises:
disabling the one or more services of the authorized electronic resource based on a predicted future state score of the predicted future state being greater than a threshold state score indicative of the candidate event corresponding to a potential adverse event.

4. The method of claim 2, wherein detecting the candidate event associated with the authorized electronic resource comprises:
receiving, from a telecommunication device, a notification of a detected interaction with the authorized electronic resource; and
detecting the candidate event based on the detected interaction.

5. The method of claim 2, wherein retrieving the event network data comprises:
accessing an event network database storing event network data for authorized electronic resources to retrieve events occurring during a lifetime of the authorized electronic resource prior to the candidate event; and
determining the event network data by filtering the event network database for the authorized electronic resources.

6. The method of claim 2, further comprising:
storing, using an electronic resource network database, electronic resource network data for a plurality of authorized electronic resources, the plurality of authorized electronic resources comprising the authorized electronic resource; and
determining the subset of state change events from the electronic resource network data for each of the plurality of authorized electronic resources.

7. The method of claim 2, further comprising:
storing, using a state change network database, state change network data associated with the authorized electronic resource, wherein the state change network data corresponds to a subset of state change events from a sequence of events associated with the authorized electronic resource, wherein each state change event in the subset of state change events is associated with a state change of the authorized electronic resource.

8. The method of claim 7, wherein storing the state change network data comprises:
storing a set of tuples, each tuple of the set of tuples corresponding to a state change event from the subset of state change events and including a date of the state change event and a label indicating a state of the authorized electronic resource for that date.

9. The method of claim 2, wherein disabling, based on the predicted future state, the one or more services of the authorized electronic resource comprises:
preventing access to secure network data associated with the authorized electronic resource; and
generating and transmitting, to a client device associated with the authorized electronic resource, an alert indicating that the secure network data was prevented from being accessed.

10. The method of claim 2, further comprising:
training, using the authorized electronic resource snapshots and the dynamically assigned labels determined based on the authorized electronic resource snapshots, an artificial intelligence model to obtain the trained artificial intelligence model, wherein the predicted future state obtained by trained artificial intelligence model comprises a likelihood of an adverse event associated with the authorized electronic resource being detected.

11. The method of claim 2, further comprising:
retrieving state change network data associated with a plurality of authorized electronic resources, the state change network data comprising a date of an event associated with a state change of a corresponding authorized electronic resource and a label indicating a state of the corresponding authorized electronic resource for that date, wherein the authorized electronic resource snapshots are derived based on the state change network data; and
generating, using the state change network data, the authorized electronic resource snapshots and the dynamically assigned labels determined based on the authorized electronic resource snapshots respectively associated with the plurality of authorized electronic resources.

12. The method of claim 11, wherein generating the authorized electronic resource snapshots and the dynamically assigned labels determined based on the authorized electronic resource snapshots comprises:
randomly selecting a first authorized electronic resource of the plurality of authorized electronic resources;
randomly selecting a sample time from a first lifetime of the first authorized electronic resource for a first authorized electronic resource snapshot of the first authorized electronic resource, wherein a first sequence of events associated with the first authorized electronic resource occur during the first lifetime;
creating a first subsequence of events from the first sequence of events comprising events occurring during the first lifetime prior to the sample time, wherein the authorized electronic resource snapshots comprise the first subsequence of events;
inputting the first subsequence of events into the trained artificial intelligence model to generate a first predicted label for the first subsequence of events indicating a likelihood of an adverse event associated with the first authorized electronic resource being detected; and
adjusting one or more parameters of the artificial intelligence model based on a loss computed using the first predicted label and a dynamically assigned label for the first subsequence of events.

13. The method of claim 12, wherein adjusting one or more parameters of the artificial intelligence model based on the loss computed using the first predicted label and the dynamically assigned label for the first subsequence of events further comprises:
retrieving a convergence condition;
determining a condition of the artificial intelligence model based on adjusting one or more parameters of the artificial intelligence model based on a loss computed using the first predicted label and the dynamically assigned label for the first subsequence of events; and
comparing the convergence condition to the condition.

14. The method of claim 13, wherein comparing the convergence condition to the condition comprises at least one of:
determining that a computed loss is less than a threshold loss indicative of the artificial intelligence model being trained;
determining that a threshold number of matches have been made between predicted labels and dynamically assigned labels; or
determining that a predefined number of authorized electronic resources or a predefined subset of authorized electronic resources of the plurality of authorized electronic resources have been selected.

15. The method of claim 12, wherein determining the dynamically assigned labels for the authorized electronic resource snapshots comprises:
identifying, prior to inputting the first subsequence of events into the trained artificial intelligence model to generate the first predicted label for the first subsequence of events, a first state change event from a subset of state change events satisfying a temporal condition indicating that the first state change event occurred temporally closest to the sample time; and
assigning a first label associated with the first state change event to the first subsequence of events, wherein the dynamically assigned labels comprise the first label associated with the first state change event.

16. The method of claim 15, wherein satisfying the temporal condition comprises:
determining an amount of time between the first state change event and the first authorized electronic resource snapshot; and
determining the amount of time between the first state change event and the first authorized electronic resource snapshot is less than a threshold amount of time.

17. One or more non-transitory computer-readable media storing computer program instructions that, when executed by one or more processors, effectuate operations comprising:
responsive to detecting a candidate event associated with an authorized electronic resource, retrieving event network data comprising a sequence of events associated with the authorized electronic resource including the candidate event;
inputting the event network data into a trained artificial intelligence model to obtain a predicted future state for the authorized electronic resource, wherein the trained artificial intelligence model is trained using authorized electronic resource snapshots and dynamically assigning labels determined from the authorized electronic resource snapshots; and
disabling, based on the predicted future state, one or more services of the authorized electronic resource.

18. The one or more non-transitory computer-readable media of claim 17, wherein disabling the one or more services comprises:
disabling the one or more services based on a predicted future state score being greater than a threshold state score; and
determining the predicted future state score being greater than the threshold state score is indicative of the candidate event corresponding to a potential adverse event.

19. The one or more non-transitory computer-readable media of claim 17, wherein disabling, based on the predicted future state, the one or more services of the authorized electronic resource comprises:
preventing access to secure network data associated with the authorized electronic resource; and
generating and transmitting, to a client device, an alert indicating that the secure network data was prevented from being accessed.

20. The one or more non-transitory computer-readable media of claim 17, wherein the operations further comprise:
training, using the authorized electronic resource snapshots and the dynamically assigned labels determined based on the authorized electronic resource snapshots, an artificial intelligence model to obtain the trained artificial intelligence model, wherein the predicted future state obtained by trained artificial intelligence model comprises a likelihood of an adverse event associated with the authorized electronic resource being detected.
